(19) United States
(12) Patent Application Publication
(10) Pub. No.: US 2020/0125846 A1
(43) Pub. Date: Apr. 23, 2020

(54) Augmented Reality System for Manufacturing Composite Parts

(71) Applicant: The Boeing Company, Chicago, IL (US)

(72) Inventors: Brian Dale Laughlin, Wichita, KS (US); Melissa Margaret Skelton, Lake Stevens, WA (US)

(21) Appl. No.: 16/167,636

(22) Filed: Oct. 23, 2018

(51) Int. Cl. G06K 9/00; G06T 19/00; G09B 19/24

(52) U.S. Cl. CPC G06K 9/00671; G09B 19/24; G06T 19/006

(57) ABSTRACT

A method, apparatus, and system for augmenting a live view of a task location. A portable computing device is localized to an object. A visualization of a task location is displayed on the live view of the object for performing a task using a model of the object and a combined map of the object. The combined map is generated from scans of the object by portable computing devices at different viewpoints to the object.

### BACKGROUND INFORMATION

### 1. Field

The present disclosure relates generally to manufacturing composite parts and in particular, to a method, apparatus, and system for manufacturing composite part using an augmented reality system.

### 2. Background

Composite parts are manufactured by laying up plies of composite material on a tool. The plies can be pre-impregnated with a resin prior to placement. These types of plies are referred to as prepreg. After the plies are laid up on the tool, the layers are cured to form a composite part.

Laying up plies in the correct locations, order and orientations specified for the composite part is important to obtain a desired level of performance. Currently, when plies are placed by human operators, the plies are placed on a tool using an overhead laser tracker (OLT) to display a guide for ply placement. This overhead laser tracker increases the accuracy in the placement of the plies on the tool.

An overhead laser tracker comprises a laser projector mounted above the layup area, a computer controller and a set of retroreflective alignment pins or reference markers, which are positioned on the tool and used as reference points to establish the tool position in three-dimensional space. The laser projector displays an outline on the tool that identifies the placement of a ply.

These types of systems are effective but require a dedicated space. For example, the laser projector requires a fixed space above the tool used to layup plies. Further the overhead laser tracker is required to be located above the tool. Additionally, overhead laser trackers are expensive to purchase and also require calibration and other maintenance.

Therefore, it would be desirable to have a method and apparatus that take into account at least some of the issues discussed above, as well as other possible issues. For example, it would be desirable to have a method and apparatus that overcome a technical problem with providing a guide for placing a ply on a tool.

### SUMMARY

An embodiment of the present disclosure provides a method for visualizing task information for a layup location on a tool. A tool is scanned using portable computing devices on human operators at different viewpoints to the tool to generate scan data. Point clouds are created by a computer system from the scan data generated by the portable computing devices. A combined map of the tool is created by the computer system using the point clouds. A portable computing device in the portable computing devices is localized to the tool using the combined map of the tool. The task information for the layup location on the tool is displayed on a live view seen through a display device in the portable computing device that has been localized using the combined map of the tool and a ply model of composite plies, wherein displayed task information augments the live view of the tool.

Another embodiment of the present disclosure provides a method for augmenting a live view of a task location. A portable computing device is localized to an object. A visualization of a task location is displayed on the live view of the object for performing a task using a model of the object and a combined map of the object, wherein the combined map is generated from scans of the object by portable computing devices at different viewpoints to the object.

Yet another embodiment provides an augmented reality system for visualizing a layup location on a tool. The augmented reality system comprises a computer system that operates to receive scan data from portable computing devices on human operators at different viewpoints to the tool to generate scan data. The computer system operates to create a plurality of maps of the tool using the scan data generated by the portable computing devices and combines the plurality of maps to form a combined map of the tool. The computer system operates to identify task information for the layup location in a ply model. The computer system operates to send the task information of the layup location on the tool to a portable computing device in the portable computing devices. The portable computing device displays the task information for the layup location on the tool on a live view seen through a display device in the portable computing device that has been localized using the combined map of the tool and a ply model of composite plies.

Still another embodiment provides an augmented reality system for augmenting a live view of a task location. The augmented reality system comprises a portable computing device, wherein the portable computing device is localized to an object and displays a visualization of a task location on the live view of the object for performing a task using a model of the object and a combined map of the object. The combined map is generated from scans of the object by portable computing devices at different viewpoints to the object.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a pictorial representation of a network of data processing systems in which illustrative embodiments may be implemented;

FIG. 2 is an illustration of a block diagram of an augmented reality environment in accordance with an illustrative embodiment;

FIG. 3 is an illustration of a block diagram of an augmented reality system used for visualizing task information for placing a composite ply at a layup location on a tool in accordance with an illustrative embodiment;

FIG. 4 is an illustration of human operators performing operations at a tool in accordance with an illustrative embodiment;

FIG. 5 is an illustration of a flowchart of a process for augmenting a live view of a task location on a portable computing device in accordance with an illustrative embodiment;

FIG. 6 is an illustration of flowchart of a process for processing scan data in accordance with an illustrative embodiment;

FIG. 7 is an illustration of a flowchart of a process for creating a combined map in accordance with an illustrative embodiment;

FIG. 8 is an illustration of a flowchart of a process for creating a combined map in accordance with an illustrative embodiment;

FIG. 9 is an illustration of a flowchart of a process for visualizing task information for a layup location on a tool in accordance with an illustrative embodiment;

FIG. 10 is an illustration of a flowchart of a process for displaying a visualization of task information in accordance with an illustrative embodiment;

FIG. 11 is an illustration of a block diagram of a data processing system in accordance with an illustrative embodiment;

FIG. 12 is an illustration of a block diagram of a portable computing device in accordance with an illustrative embodiment;

FIG. 13 is an illustration of a block diagram of an aircraft manufacturing and service method in accordance with an illustrative embodiment;

FIG. 14 is an illustration of a block diagram of an aircraft in which an illustrative embodiment may be implemented; and

FIG. 15 is an illustration of a block diagram of a product management system in accordance with an illustrative embodiment.

### DETAILED DESCRIPTION

The illustrative embodiments recognize and take into account one or more different considerations. For example, the illustrative embodiments recognize and take into account that portable computing devices are to be used in place of an overhead laser tracker to display task locations. The illustrative embodiments recognize and take into account, however, the use of a portable computing device involves the portable computing device localizing itself to the tool. The illustrative embodiments recognize and take in account that identifying the location and orientation of the portable computing device relative to the tool and corresponding the view of the tool to a model of the tool provides challenges not present with an overhead laser tracker. The illustrative embodiments recognize and take in account that generating a map from a portable computing device may not have a desired level of accuracy.

The illustrative embodiments recognize and take into account that the technical solution can involve using scans of the tool from multiple portable computing devices at different viewpoints. Thus, the illustrative embodiments provide a method, apparatus, and system for visualizing information for performing tasks on an object. The illustrative embodiments provide a method, apparatus, and system for visualizing task locations. The visualization of task locations includes displaying information used to perform operations at the task locations in addition to identifying the task locations.

In one illustrative example, a method augments a live view of a task location. A portable computing device is localized to an object. A visualization of a task location is displayed on a live view of the object for performing a task using a model of the object and a combined map of the object, wherein the combined map is generated from scans of the object by portable computing devices at different viewpoints to the object.

In another illustrative example, a method provides visualization of task information for a layup location on a tool. A tool is scanned using portable computing devices on human operators at different viewpoints to the tool to generate scan data. Point clouds are created by a computer system from the scan data generated by the portable computing devices. A combined map of the tool is created by the computer system using the point clouds. A portable computing device in the portable computing devices is localized to the tool using the combined map of the tool. The task information for the layup location on the tool is displayed on a live view seen through a display device in the portable computing device that has been localized using the combined map of the tool and a ply model of composite plies, wherein displayed task information augments the live view of the tool.

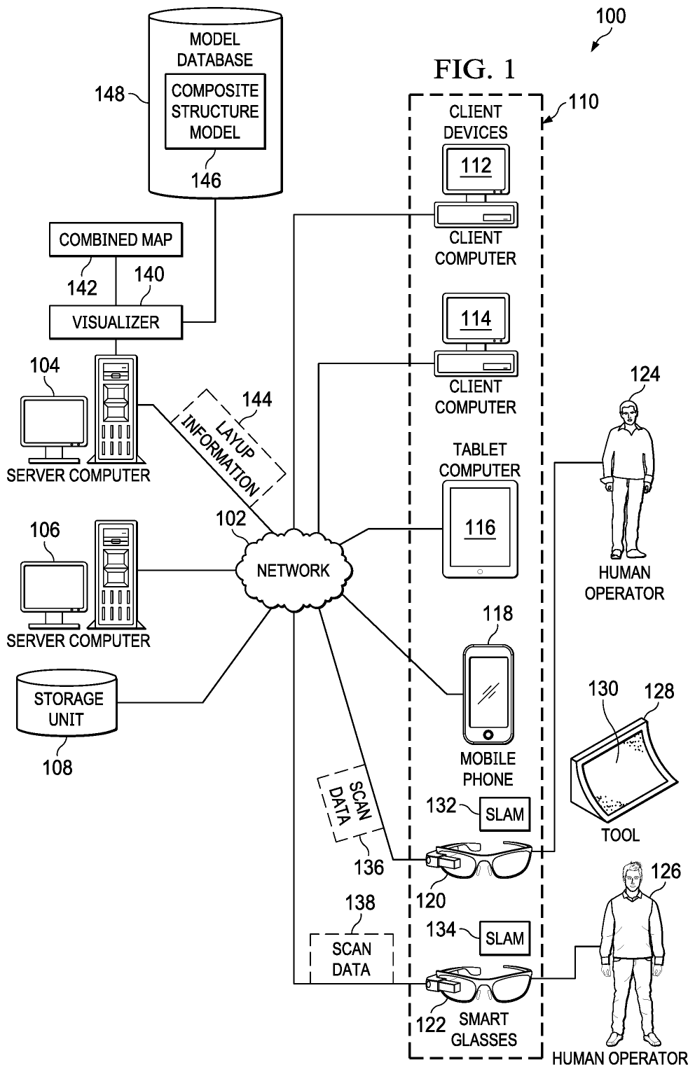

With reference now to the figures and, in particular, with reference to FIG. 1, an illustration of a pictorial representation of a network of data processing systems is depicted in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client devices 110 connect to network 102. As depicted, client devices 110 include client computer 112 and client computer 114. Client devices 110 can be, for example, computers, workstations, or network computers. In the depicted example, server computer 104 provides information, such as boot files, operating system images, and applications to client devices 110. Further, client devices 110 can also include other types of client devices such as tablet computer 116, mobile phone 118, smart glasses 120, and smart glasses 122. In this illustrative example, server computer 104, server computer 106, storage unit 108, and client devices 110 are network devices that connect to network 102 in which network 102 is the communications media for these network devices. Some or all of client devices 110 may form an Internet of things (IoT) in which these physical devices can connect to network 102 and exchange information with each other over network 102.

Client devices 110 are clients to server computer 104 and server computer 106 in this example. Network data processing system 100 may include additional server computers, client computers, and other devices not shown. Client devices 110 connect to network 102 utilizing at least one of wired, optical fiber, or wireless connections.

Program code located in network data processing system 100 can be stored on a computer-recordable storage medium and downloaded to a data processing system or other device for use. For example, program code can be stored on a computer-recordable storage medium on server computer 104 and downloaded to client devices 110 over network 102 for use on client devices 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using a number of different types of networks. For example, network 102 can be comprised of at least one of the Internet, an intranet, a local area network (LAN), a metropolitan area network (MAN), or a wide area network (WAN). FIG. 1 is intended as an example, and not as an architectural limitation for the different illustrative embodiments.

As used herein, “a number of” when used with reference to items, means one or more items. For example, “a number of different types of networks” is one or more different types of networks.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

In this illustrative example, human operator 124 operates smart glasses 120 and human operator 126 operates smart glasses 122. In this example, human operator 124 and human operator 126 place layers of composite plies on tool as part of a process for fabricating a composite structure. The composite structure can be, for example, a composite part for an aircraft.

In this illustrative example, composite ply 130 has already been laid on tool 128. As depicted, human operator 124 and human operator 126 are preparing to place another composite ply onto tool 128.

In this illustrative example, the visualization of the placement of the new composite ply can be performed using smart glasses 120 operated by human operator 124 and smart glasses 122 operated by human operator 126.

As depicted, smart glasses 120 and smart glasses 122 operate to scan tool 128. In this illustrative example, the scan can be performed by smart glasses 120 using simultaneous localization and mapping (SLAM) process 132 and by smart glasses 122 using simultaneous location and mapping (SLAM) process 134. The scan can include scanning tool 128 with a laser, lidar, an infrared scanner, or other suitable device the generates data about the surface of tool 128.

In this illustrative example, smart glasses 120 and smart glasses 122 each have a different viewpoint of tool 128. As result, scanning tool 128 from these different viewpoints can result in a more accurate scan of tool 128.

For example, smart glasses 120 may not have a view of some locations on tool 128. Smart glasses 122 may have a view of these locations missed by smart glasses 120. In a similar fashion, smart glasses 122 may not have view of some locations that are within the view of smart glasses 120.

The scan data 136 generated by smart glasses 120 and scan data 138 generated by smart glasses 122 from the scan of tool 128 are sent to visualizer 140 running on server computer 104. Scan data 136 and scan data 138 can be point clouds generated by the smart glasses. In other illustrative examples, scan data 136 and scan data 138 can be other information that can be used to generate point clouds or other information suitable for mapping tool 128.

In this illustrative example, visualizer 140 generates combined map 142 of tool 128 using scan data 136 and scan data 138. Combined map 142 includes the placement of composite ply 130.

By using scan data 136 and scan data 138 to generate combined map 142, at least one of a more complete or accurate map of tool is generated. For example, scan data 136 and scan data 138 can cover more locations on tool 128 than just using scan data 136 or scan data 138 with respect to the different viewpoints from which scan data 136 and scan data 138 are generated.

In this illustrative example, layup information 144 about layup locations on tool 128 are obtained by visualizer 140 accessing composite structure model 146 in model database 148. In this illustrative example, visualizer 140 sends layup information 144 smart glasses 120 and smart glasses 122.

In this illustrative example, smart glasses 120 smart glasses 122 localize themselves with respect to tool 128 using the simultaneous location and mapping (SLAM) processes running on the smart glasses. With the position of smart glasses 120 and smart glasses 122 layup information 144 can be displayed to augment the live views seen through smart glasses 120 and smart glasses 122. For example, layup information 144 can be an outline identifying where a new composite ply should be laid up on tool 128.

In these illustrative examples, smart glasses 120 and smart glasses 122 can continue scan tool 128 and send scan data 136 and scan data 138 as human operator 124 and human operator 126 move to perform operations to layup composite plies for the composite part. As the human operators move with respect to tool 128, the viewpoint of the smart glasses for tool 128 can change. As result, additional scan data sent from the smart glasses can provide additional information to increase the accuracy of combined map 142 for tool 128.

Further, the additional scanning can also provide updates to changes to the layup of composite plies on tool 128. As composite plies are added or are being positioned, scan data of these operations can be used to update combined map 142.

In these illustrative examples, the generation of updates to combined map 142 are performed in real-time. In other words, scan data can be continuously or periodically generated by smart glasses 120 and smart glasses 122 while human operator 124 and human operator 126 are performing operations to layup composite plies on tool 128.

As a result, combined map 142 can be a dynamic map of tool 128 along with any composite plies laid up on tool 128. In this manner, the accuracy of combined map 142 can be increased and can include changes such as the placement of composite plies on tool 128.

The illustration of this example in FIG. 1 is not meant to limit the manner in which other illustrative examples can be implemented. For example, one or more human operators with smart glasses can be present in generating scan data of tool 128. In another illustrative example, a different type of object other than tool 128 can be present. For example, the human operators can perform the rework operation to form a scarf and install a patch comprised of layers of composite material. With this type of operation, layup information 144 can include a placement for the patch. Further, scarf information also can present to aid the human operators in forming the scarf.

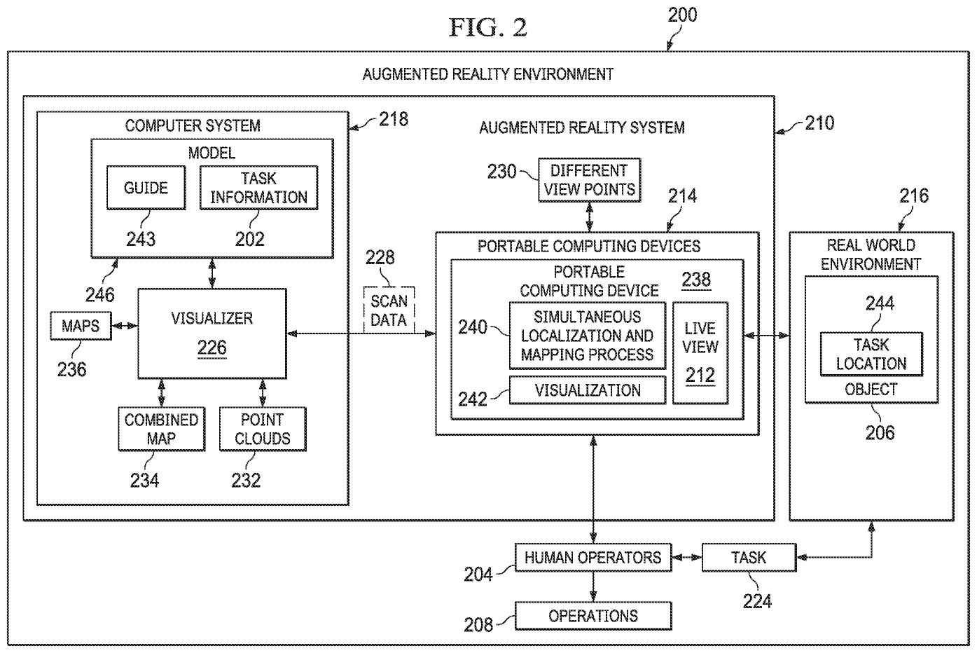

With reference to FIG. 2, an illustration of a block diagram of an augmented reality environment is depicted in accordance with an illustrative embodiment. The different hardware components in network data processing system 100 in FIG. 1 are examples of components that may be used in augmented reality environment 200.

As depicted, augmented reality environment 200 is an environment in which task information 202 can be visualized by a number of human operators 204 viewing object 206. In this example, the number of human operators 204 can perform operations 208 on object 206. In this illustrative example, object 206 can be selected from a group comprising a tool, a wall, a workpiece, a wing, a fuselage section, an engine, a building, an aircraft, a vehicle, or some other suitable type of object.

In this illustrative example, the visualization of information 202 is performed using augmented reality system 210. As depicted, augmented reality system 210 augments live view 212 of task location 244 for object 206. Live view 212 is a view of real world environment 216 seen through portable computing devices 214. In this illustrative example, live view 212 can be images or video generated by camera in the portable computing device and displayed on a display device in the portable computing device in real-time. In other examples, live view 212 can be directly seen by an operator through the portable computing device.

In this example, task information 202 can be displayed on live view 212 to augment live view 212 of real-world environment 216. Task information 202 can include at least one of a task location, an outline of a ply, text with instructions for performing an operation, an image, a graphic, a video, or other suitable types of information that can be overlaid on live view 212 of object 206.

As depicted, augmented reality system comprises computer system 218 and portable computing devices 214. Computer system 218 is a physical hardware system and includes one or more data processing systems. When more than one data processing system is present in computer system 218, those data processing systems are in communication with each other using a communications medium. The communications medium can be a network. The data processing systems can be selected from at least one of a computer, a server computer, a tablet computer, or some other suitable data processing system.

Portable computing devices 214 are physical hardware devices that are used by human operators 204 to visualize task information 202 about object 206.

Portable computing devices 214 can be selected from at least one of a mobile phone, a tablet computer, smart glasses, a head mounted display, or some other suitable computing device. In this illustrative example, portable computing devices 214 scan object 206 using at least one of a laser scanner, a structured light three-dimensional scanner, an infrared light scanner, or some other suitable type of device that can create scan data 228.

In this illustrative example, augmented reality system enables one or more of human operators 204 operating portable computing devices 214 to visualize a live view 212 of object 206 by augmenting live view 212 with task information 202 for performing task 224 on object 206.

In the illustrative examples, task 224 can take a number of different forms. Task 224 can be selected from at least one of placing a composite ply, applying a plague, applying an applique, performing an inspection of the task location, drilling a hole, installing a fastener, connecting a part to an assembly, removing a part, a surgery procedure, forming a metal bond, applying paint, making a measurement, or some other operation for task 224.

In this illustrative example, visualizer 226 in computer system 218 is in communication with portable computing devices 214. These components are in communication with each other using wireless communications links in these illustrative examples.

In this illustrative example, scan data 228 is generated from scanning object 206 with the portable computing devices 214 on human operators 204 at different viewpoints 230 to object 206. In this illustrative example, scan data 228 is generated and received in real-time.

In the illustrative examples, a viewpoint is a perspective from a sensor in a portable computing device. For example, the sensor can be a camera or a scanner. The viewpoint can be a position comprising a location in three-dimensional space and an orientation for portable computing device.

Visualizer 226 operates to receive scan data 228 from portable computing devices 214. As depicted, visualizer 226 creates point clouds 232 from scan data 228 generated by portable computing devices 214. In this illustrative example, visualizer 206 can receive scan data 228 in real-time. Visualizer 226 creates combined map 234 of object 206 using point clouds 232.

In creating combined map 234, visualizer 226 creates a map from each point cloud in point clouds 232 to form a plurality of maps 236 and combines the plurality of maps 236 to form the combined map 234. The combining of the plurality of maps 236 can be performed by identifying common features between the point clouds in using those local feature correspondences to combine the point clouds. These common features can be at least one of features occurring on object 206, fiducial markers placed on object 206, or fiducial markers placed near object 206. Features on object 206 can include at least one of a hole, fastener, a seam, an elongated protrusion, a corner, an end or some other feature on object 206. In another illustrative example, combined map 234 can be generated by combining point clouds 232 and then creating combined map 234.

In the illustrative example, combined map 234 and maps 236 are three-dimensional maps. These maps represent the surface of object 206 as well as any other items or things that may be on or touching object 206.

In this illustrative example, portable computing device 238 in portable computing devices 214 is localized to object 206. The localization identifies the position of computing device 238 to object 206. The position of portable computing device 238 is a location and orientation of portable computing device 238 in three-dimensional space.

This localization can be performed using simultaneous localization and mapping process (SLAM) 240 running on portable computing device 238. Portable computing device 238 displays task information 202 for task location 244 on live view 212 of object 206. In this illustrative example, visualization 242 of task location 244 can be performed using task information 202. For example, task information 202 can include the coordinates for task location 244. Visualization 242 can be a graphical indicator visually identifying task location 244 on live view 212 of object 206. Visualization 242 is displayed for use in performing task 224 on object 206. Additionally, visualization 242 can also include other information such as guide 243 to aid in the placement of a component such as a part, assembly, composite ply, or other components for object 206.

For example, guide 243 can take the form of an outline of a composite ply, a pattern for composite ply, an outline of the hole, or other suitable graphical information to guide human operators 204 in performing operations 208 to perform task 224 on object 206 and task location 244.

Further, guide 243 can be used as the visual indication of task location 244. For example, guide 243 can be an outline of composite ply that is displayed at task location 244 in the position where the composite ply should be placed. In other words, the composite ply can be placed to fit within the outline displayed on live view 212 of object 206.

The visualization is made on live view 212 of object 206 to indicate the location of task location 244 using model 246 of object 206 and combined map 234 generated from scans of object 206 performed by portable computing devices 214. In this illustrative example, model 246 is a reference map that can be compared to combined map 234 generated from scan data 228. Model 246 and combined map 234 can be aligned with each other for use in generating at least one of coordinates, program code, instructions, or other information used to display task information 202 in the desired location on live view 212 of object 206. For example, if task information 202 includes a location of a composite ply, these two models can be used to display an outline of the composite ply from model 242 of object 206 on the correct position in the live view of object 206.

In the illustrative examples, task 224 to be performed at task location 244 can take a number of different forms. For example, task location 244 is for at least one of a composite ply, a part in an assembly in which the object is the assembly, a plaque, an applique, or some other suitable line. Task 224 can be selected from at least one of placing a composite ply, applying a plague, applying an applique, performing an inspection of the task location, drilling a hole, installing a fastener, connecting a part to an assembly, removing a part, or some operation for task 224.

In the illustrative example, visualizer 226 can be implemented in software, hardware, firmware or a combination thereof. When software is used, the operations performed by visualizer 226 can be implemented in program code configured to run on hardware, such as a processor unit. When firmware is used, the operations performed by visualizer 226 can be implemented in program code and data and stored in persistent memory to run on a processor unit. When hardware is employed, the hardware may include circuits that operate to perform the operations in visualizer 226.

In the illustrative examples, the hardware may take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

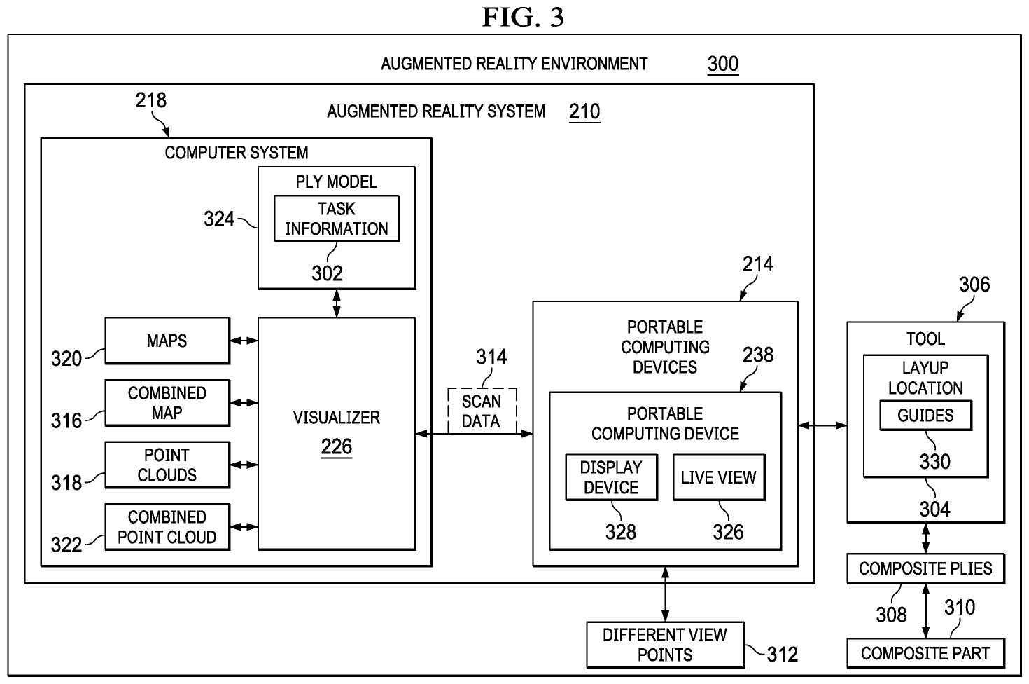

With reference next to FIG. 3, an illustration of a block diagram of an augmented reality system used for visualizing task information for placing a composite ply at a layup location on a tool is depicted in accordance with an illustrative embodiment. In the illustrative examples, the same reference numeral may be used in more than one figure. This reuse of a reference numeral in different figures represents the same element in the different figures.

In this illustrative example, augmented reality system 210 is used in augmented reality environment 300 for visualizing task information 302 for layup location 304 on tool 306. In this particular example, tool 306 is a structure on which composite plies 308 can be laid up as part of a process for manufacturing composite part 310. Tool 306 can be, for example, selected from a group comprising a mandrel, a mold, a composite tool, and other suitable types of tools.

In this example, visualizer 226 in computer system 218 operates to receive scan data 314 from portable computing devices 214 on human operators 204 at different viewpoints 312 to tool 306 to generate scan data 314. Further, visualizer 226 creates combined map 316 of tool 306 using scan data 314 obtained from portable computing devices 214 at different viewpoints 312 of tool 306.

In one illustrative example, visualizer 226 creates point clouds 318 of tool 306 from scan data 314. In creating point clouds 318 of tool 306, point clouds 318 can also include any composite plies, release films, or other components that have been placed on tool 306. Each point cloud in point clouds 318 is generated from scan data 314 received from a portable computing device in portable computing devices 214. Visualizer 226 creates create a plurality of maps 320 of tool 306 using scan data 314 generated by portable computing devices 214 and combines the plurality of maps 320 for forming combined map 316 of tool 306.

In this example, visualizer 226 identifies common reference points in the plurality of maps 320 and combines the plurality of maps 320 using the common reference points to form combined map 316. These reference points may be for at least one of features on tool 306 or fiducial markers used with tool 306.

In this example, combined map 316 has increased accuracy from the plurality of maps 320 created from scan data 314 generated different viewpoints 312. For example, if only a single map is used, the scan data for that single map may be missing data for portions of tool 306 from the scan performed from the viewpoint of the portable computing device. For example, scan data can be missing for portions of the object 206 not visible to the portable computing device.

By combining scan data from different viewpoints, a more complete data set is present for generating a map of tool 306. As result, increased accuracy is present

In another illustrative example, point clouds 318 can be combined to form combined point cloud 322. Visualizer 206 can then generate combined map 316 from combined point cloud 322.

As depicted, visualizer 226 identifies task information 302 for layup location 304 in ply model 324 of composite plies 308 for composite part 310. Task information 302 can include information selected from at least one of an identification of files, ply order, ply orientation, placement information, a curing temperature, a curing time, or other suitable information for fabricating composite part 310 on tool 306.

Visualizer 226 sends task information 302 for layup location 304 on tool 306 to portable computing device 238 in portable computing devices 214. In this illustrative example, portable computing device 238 displays task information 302 for layup location 304 on tool 306 on live view 326 of tool 306 seen through display device 328 in portable computing device 238 which has been localized using combined map 316 of tool 306 and ply model 324 of composite plies 308. Displayed task information augments live view 326 of tool 306.

As depicted, portable computing device 238 identifies layup location 304 in ply model 324 of composite plies 308 for composite part 310. This determination can be made a number of different ways. For example, portable computing device 238 can contain a local copy of ply model 324. In another illustrative example, mobile computing device 238 can access ply model 324 by sending requests to visualizer 226.

As depicted, portable computing device 214 determines a location on live view 326 for a number of guides 330 for a number of composite plies 308 using ply model 324 and combined map 316. Portable computing device 214 displays the number of guides 330 for a number of composite plies 308 at the location on live view 326 of tool 306 seen through display device 328 in portable computing device 238 that has been localized to tool 306. As depicted, the number of guides 330 aids in placement of the number of composite plies 308 on tool 306. This guide can be an aid used to layup a composite ply in a correct position for at least one of fabricating a composite part or reworking the composite part 310 on tool 306. In this illustrative example, the number of guides 330 can be at least one of an outline, a pattern, or some other suitable visual display that guides placement of a composite ply on tool 306.

In another illustrative example, the number of guides 330 can include can be a number of additional outlines or patterns for a number of composite plies 308 at layup location 304 on live view 326 of tool 306 seen through display device 328 in portable computing device 238 that has been localized.

The number of additional outlines or patterns illustrates a number of prior placements for the number of composite plies 308 on the tool 306. These prior placements can be placements made previously on the same tool or an identical tool for the same composite part. In this manner, the comparison of the of composite ply placement can be made.

Additionally, portable computing device 238 can display other task information in task information 302 in addition to guides 330 at layup location 304 as part of an augmented reality display in which the other task information is displayed on live view 326 of tool 306. For example, portable computing device 238 can display at least one of a ply number, an instruction, an image, or video for placing the number of composite plies.

In one illustrative example, one or more technical solutions are present that overcome a technical problem with providing a guide for placing a ply on a tool. In the illustrative examples, one or more technical solutions provide visualizations of task locations using portable computing devices in place of an overhead laser tracker. In the illustrative examples, one or more technical solution uses scans of the tool from multiple portable computing devices at different viewpoints to increase the accuracy of the visualizations of task locations. One or more technical solutions involve combining scan data received from the portable computing devices to form a combined map of the object, such as a tool, such that scan data from one portable computing device that is missing scan data for a portion of the tool can be supplemented with scan data including the portion of the tool from another portable computing device.

As a result, one or more technical solutions may provide a technical effect providing visualization of task locations on objects with increased accuracy by using scan data from multiple portable computing devices as compared to currently used techniques.

Computer system 218 can be configured to perform at least one of the steps, operations, or actions described in the different illustrative examples using software, hardware, firmware or a combination thereof. As a result, computer system 218 operates as a special purpose computer system in which visualizer 226 in computer system 218 enables visualizing task information 302 on live view 212 of object 206 in a manner that provides an augmented reality display in which task information 202 is overlaid on live view 212 of object 206. In particular, visualizer 226 transforms computer system 216 into a special purpose computer system as compared to currently available general computer systems that do not have visualizer 226.

The illustration of augmented reality system 210 in FIG. 2 and in FIG. 3 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, simultaneous localization and mapping process 240 can run on computer system 218 rather than on portable computing device 238.

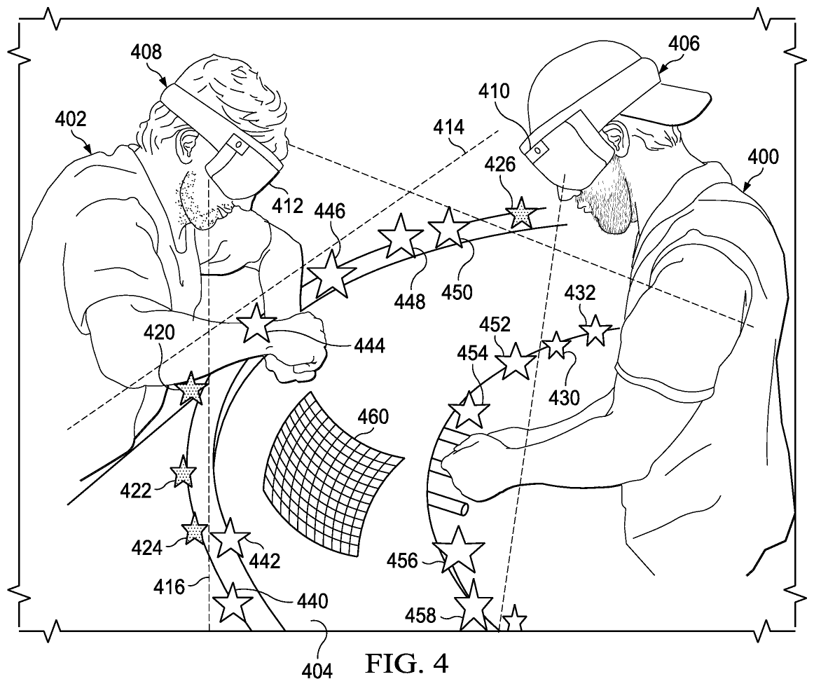

Turning to FIG. 4, an illustration of human operators performing operations at a tool is depicted in accordance with an illustrative embodiment. In this illustrative example, human operator 400 and human operator 402 perform operations to layup composite plies on tool 404 as part of a process to fabricate a composite part. In yet another illustrative example, one or more tasks may be performed in addition to task 224. For example, task 224 can be placement of a composite ply. A subsequent task can be inspection of the composite ply to determine whether the placement is correct.

As depicted, human operator 400 wears smart glasses 406, and human operator 402 wears smart glasses 408. Smart glasses 406 and smart glasses 408 are examples of implementations for portable computing devices 214 shown in block form in FIG. 2 and FIG. 3.

As depicted, smart glasses 406 and smart glasses 408 are at different viewpoints with respect to tool 404. In this example, smart glasses 406 as viewpoint 410 and smart glasses 408 has viewpoint 412. These viewpoints are directed towards tool 404 from different positions. In other words, viewpoint 410 and viewpoint 412 are different viewpoints from each other.

In this illustrative example, smart glasses 406 scans tool 404 through view 414. In this illustrative example, the scan is performed using at least one of a laser scanner, and infrared scanner, or some other suitable type of sensor. For example, smart glasses 408 may use a laser scanner, while smart glasses 406 may be use an infrared scanner. As another example, smart glasses 406 and smart glasses 406 may each have both a laser scanner and infrared scanner.

View 414 is the three-dimensional space that can be scanned by smart glasses 406. View 416 is the three-dimensional space that can be scanned by smart glasses 408. These views can also define the live views seen by operates through the smart glasses. For example, view 414 can be a live view seen by human operator 400 through smart glasses 406. View 416 can be the live view seen by human operator 402 through smart glasses 408. In other illustrative examples, the view for scanning and view for the live view may be different but from the same viewpoint. A view is the portion of augmented reality environment 300 that can be scanned or seen by a sensor in a portable computing device.

Scanning these views from the different viewpoints results in two sets of scans that have different scan data. The scan data can be used to generate a combined map that combines data from both of the scans. This combined map is more accurate than using a scan only from one of the smart glasses.

For example, smart glasses 406 and smart glasses 408 can scan tool 404 in which some locations are only visible in view 414 for smart glasses 406 and some locations are visible only to view 416 for smart glasses 408. With the scan, some locations are visible in the views for both smart glasses.

For example, in view 414 for smart glasses 406, location 420, location 422, location 424, location 426 can be scanned by smart glasses 406 as well as being in the live view of smart glasses 406. These locations, however, are not within view 416 for smart glasses 408.

As depicted, in view 416 for smart glasses 408, location 430 and location 432 can be scanned and are visible in the live view of smart glasses 408. These locations are not within view 414 for smart glasses 406.

In this illustrative example, location 440, location 442, location 444, location 446, location 448, location 450, location 452, location 454, patient 456, and location 458 are locations that are scannable from view 414 of smart glasses 406 and view 416 of smart glasses 408.

As a result, the scan data generated by each of the smart glasses includes common locations scanned by both of the smart glasses as well as locations that are standby only one of the smart glasses. By using the scan data from these two smart glasses from the different viewpoints, a more accurate map of tool 404 can be generated for use in laying up composite layers for a composite part.

In this illustrative example, smart glasses 406 and smart glasses 408 localized themselves using processes running on these smart classes. These processes can include, for example, currently available simultaneous localization and mapping processes. In other words, smart glasses 406 and smart glasses 408 can identify their positions with respect to tool 404. In this illustrative example, the positions of smart glasses 406 and smart glasses 408 are in three-dimensional space and include an orientation.

Further, the smart glasses can identify the corresponding location with respect to a ply model for the composite part. Display model also can include a model of tool 404 and the layup of plies on tool 404 that form the composite part.

In this illustrative example, pattern 460 is displayed on the live view seen through both smart glasses 406 and smart glasses 408 to provide a visualization of the placement for a composite layer on tool 404. With the scan data generated by both smart glasses, the standard can be combined to more accurately index or locate pattern 460 on tool 404.

Further, as human operator 400 and human operator 402 move, additional scans of tool 404 can be made. These additional scans can be used with the already generated scans of tool 404 to improve the accuracy of the map for tool 404. Further, the scans can also include any composite plies that have been placed on tool 404. These scans can also verify the accuracy of plies that have been placed on tool in addition to providing a guide for additional plies that are to be placed on tool 404 on top of composite plies that already been placed on tool 404.

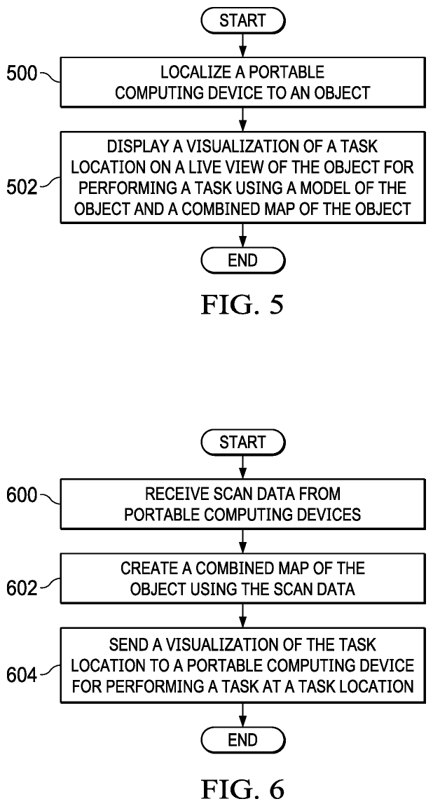

Turning next to FIG. 5, an illustration of a flowchart of a process for augmenting a live view of a task location on a portable computing device is depicted in accordance with an illustrative embodiment. The process in FIG. 5 can be implemented in hardware, software, or both. When implemented in software, the process can take the form of program code that is run by one or more processor units located in one or more hardware devices in one or more computer systems. For example, the process can be implemented in at least one of smart glasses 120 in FIG. 1, smart glasses 122 in FIG. 1, portable computing devices 214 including portable computing device 238 in augmented reality system 210 in in FIG. 2, smart glasses 406 in FIG. 4, or smart glasses 408 in FIG. 4.

The process begins by localizing a portable computing device to an object (operation 500). The process displays a visualization of a task location on a live view of the object for performing a task using a model of the object and a combined map of the object (operation 502). The combined map is generated from scans of the object by portable computing devices at different viewpoints to the object. The process terminates thereafter.

Operation 502 can be performed in a number of different ways. For example, the model of the object in the combined map of the object can be downloaded from the computer system to the portable computing device. The portable computing device can then use these models to display the visualization of the task location. This visualization can be, for example, an outline of the ply in the proper location on the tool. In another illustrative example, the computer system can generate the outline and identify the placement on the live view for the portable computing device. The computer system can then send the outline to the portable computing device along with at least one of program code, instructions, or other information needed to display the outline on the live view seen through the portable computing device.

With reference to FIG. 6, an illustration of flowchart of a process for processing scan data is depicted in accordance with an illustrative embodiment. The process in FIG. 6 can be implemented in hardware, software, or both. When implemented in software, the process can take the form of program code that is run by one or more processor units located in one or more hardware devices in one or more computer systems. For example, the process can be implemented in at least one of visualizer 140 running on server computer 104 in FIG. 1 or visualizer 226 in computer system 218 in FIG. 2.

The process begins by receiving scan data from portable computing devices (operation 600). The scan data is generated from scanning the object with the portable computing devices on human operators at different viewpoints to the object.

The process creates a combined map of the object using the scan data (operation 602). The process sends a visualization of the task location to a portable computing device for performing a task at a task location (operation 604). The process terminates thereafter.

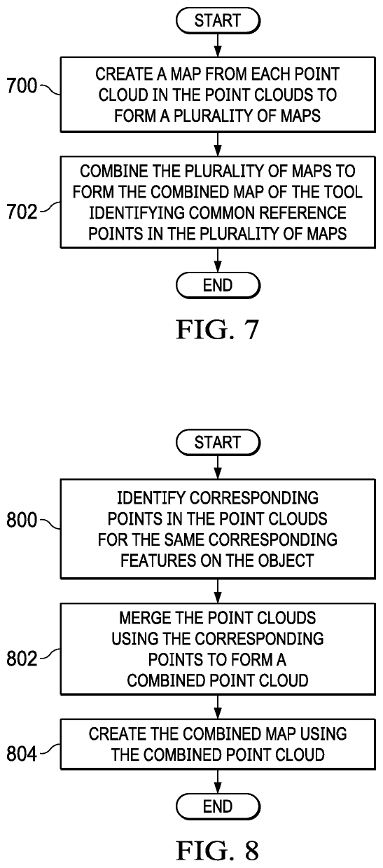

With reference next to FIG. 7, an illustration of a flowchart of a process for creating a combined map is depicted in accordance with an illustrative embodiment. The process in FIG. 7 can be implemented in hardware, software, or both. When implemented in software, the process can take the form of program code that is run by one of more processor units located in one or more hardware devices in one or more computer systems. For example, the process can be implemented in at least one of visualizer 140 running on server computer 104 in FIG. 1 or visualizer 226 in computer system 218 in FIG. 2.

The process begins by creating a map from each point cloud in the point clouds to form a plurality of maps (operation 700). The process combines the plurality of maps to form the combined map of the tool identifying common reference points in the plurality of maps (operation 702). The process terminates thereafter.

In operation 702, the maps are combined using the common reference points. These common reference points can be selected for features that are present in each of the plurality of maps. The combined map has increased accuracy from the maps created from scan data generated the different viewpoints.

With reference next to FIG. 8, an illustration of a flowchart of a process for creating a combined map is depicted in accordance with an illustrative embodiment. The process in FIG. 8 can be implemented in hardware, software, or both. When implemented in software, the process can take the form of program code that is run by one of more processor units located in one or more hardware devices in one or more computer systems. For example, the process can be implemented in at least one of visualizer 140 running on server computer 104 in FIG. 1 or visualizer 226 in computer system 218 in FIG. 2.

The process begins by identifying corresponding points in the point clouds for the same corresponding features on the object (operation 800). In operation 800, the number of corresponding points for the same correspond features can be, for example, 3 or 4 points. The process merges the point clouds using the corresponding points to form a combined point cloud (operation 802). The process creates the combined map using the combined point cloud (operation 804). The process terminates thereafter.

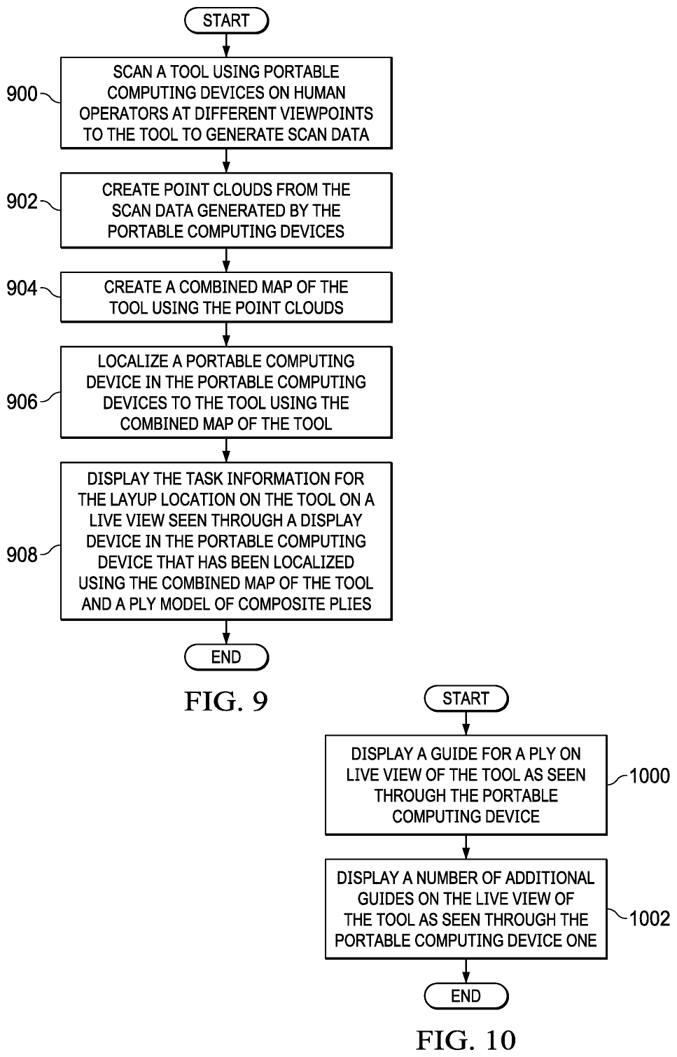

In FIG. 9, an illustration of a flowchart of a process for visualizing task information for a layup location on a tool is depicted in accordance with an illustrative embodiment. The process in FIG. 9 can be implemented in hardware, software, or both. When implemented in software, the process can take the form of program code that is run by one of more processor units located in one or more hardware devices in one or more computer systems. For example, the process can be implemented in augmented reality system 210 in FIG. 3. The operations can be implemented in at least one of computer system 218 or portable computing devise 214 in FIG. 3. The operation can be implemented to provide a visualization of task information 302 on live view 326 of tool 306. This type of display augments live view 326 to provide an augmented reality display to a human operator.

The process begins by scanning a tool using portable computing devices on human operators at different viewpoints to the tool to generate scan data (operation 900). The process creates point clouds from the scan data generated by the portable computing devices (operation 902). The process creates a combined map of the tool using the point clouds (operation 904).

The process localizes a portable computing device in the portable computing devices to the tool using the combined map of the tool (operation 906). The process displays the task information for the layup location on the tool on a live view seen through a display device in the portable computing device that has been localized using the combined map of the tool and a ply model of composite plies (operation 908). The process terminates thereafter.

With reference next to FIG. 10, an illustration of a flowchart of a process for displaying a visualization of task information is depicted in accordance with an illustrative embodiment. The process illustrated in FIG. 10 is an example of one implementation for operation 502 in FIG. 5 and operation 908 in FIG. 9.

The process begins by displaying a guide for a ply on live view of the tool as seen through the portable computing device (operation 1000). The guide displayed in operation 1000 is for next ply be placed on the tool.

The process displays a number of additional guides on the live view of the tool as seen through the portable computing device one (operation 1002). The display of the number of additional guides can be made in a manner that distinguishes number of additional guides from the guide for the ply. In this example, the number of additional guides can be for composite plies already placed in the tool. In this manner, the alignment of previously composite plies can be identified and visualized in the augmented reality display of the tool. This augmented reality display can be used to determine whether prior composite plies have shifted during the layup of composite plies on the tool.

Additionally, the number additional guides can also provide a visualization of how the same ply was previously placed on the tool in prior operations to form the composite part. The placement of prior composite plies can be obtained from a database containing history of composite ply placements. The history of composite ply placements can be identified from scans performed during placement of the composite plies. In this manner, an identification of changes between the current placement and prior placements can be visualized. These changes can occur from at least one of a change in ply dimensions, slippages, changes to the tool, or other potential sources that can change the alignment for the same ply over time.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams may be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

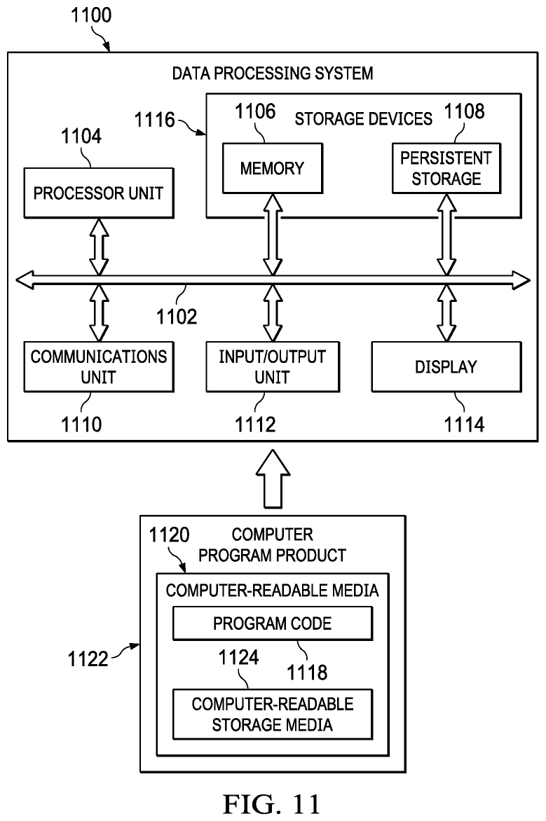

Turning now to FIG. 11, an illustration of a block diagram of a data processing system is depicted in accordance with an illustrative embodiment. Data processing system 1100 can be used to implement server computer 104, server computer 106, client devices 110, in FIG. 1. Data processing system 1100 can also be used to implement computer system 218 in FIG. 2 and FIG. 3. In this illustrative example, data processing system 1100 includes communications framework 1102, which provides communications between processor unit 1104, memory 1106, persistent storage 1108, communications unit 1110, input/output (I/O) unit 1112, and display 1114. In this example, communications framework 1102 takes the form of a bus system.

Processor unit 1104 serves to execute instructions for software that can be loaded into memory 1106. Processor unit 1104 include one or more processors. For example, processor unit 1104 can be selected from at least one of a multicore processor, a central processing unit (CPU), a graphics processing unit (GPU), a physics processing unit (PPU), a digital signal processor (DSP), a network processor, or some other suitable type of processor.

Memory 1106 and persistent storage 1108 are examples of storage devices 1116. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 1116 may also be referred to as computer-readable storage devices in these illustrative examples. Memory 1106, in these examples, can be, for example, a random-access memory or any other suitable volatile or non-volatile storage device. Persistent storage 1108 may take various forms, depending on the particular implementation.

For example, persistent storage 1108 may contain one or more components or devices. For example, persistent storage 1108 can be a hard drive, a solid-state drive (SSD), a flash memory, a rewritable optical disk, a rewritable magnetic tape, or some combination of the above. The media used by persistent storage 1108 also can be removable. For example, a removable hard drive can be used for persistent storage 1108.

Communications unit 1110, in these illustrative examples, provides for communications with other data processing systems or devices. In these illustrative examples, communications unit 1110 is a network interface card.

Input/output unit 1112 allows for input and output of data with other devices that can be connected to data processing system 1100. For example, input/output unit 1112 may provide a connection for user input through at least one of a keyboard, a mouse, or some other suitable input device. Further, input/output unit 1112 may send output to a printer. Display 1114 provides a mechanism to display information to a user.

Instructions for at least one of the operating system, applications, or programs can be located in storage devices 1116, which are in communication with processor unit 1104 through communications framework 1102. The processes of the different embodiments can be performed by processor unit 1104 using computer-implemented instructions, which may be located in a memory, such as memory 1106.

These instructions are referred to as program code, computer usable program code, or computer-readable program code that can be read and executed by a processor in processor unit 1104. The program code in the different embodiments can be embodied on different physical or computer-readable storage media, such as memory 1106 or persistent storage 1108.

Program code 1118 is located in a functional form on computer-readable media 1120 that is selectively removable and can be loaded onto or transferred to data processing system 1100 for execution by processor unit 1104. Program code 1118 and computer-readable media 1120 form computer program product 1122 in these illustrative examples. In this illustrative example, computer-readable media 1120 is computer-readable storage media 1124.

In these illustrative examples, computer-readable storage media 1124 is a physical or tangible storage device used to store program code 1118 rather than a medium that propagates or transmits program code 1118.

Alternatively, program code 1118 can be transferred to data processing system 1100 using a computer-readable signal media. The computer-readable signal media can be, for example, a propagated data signal containing program code 1118. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

The different components illustrated for data processing system 1100 are not meant to provide architectural limitations to the manner in which different embodiments can be implemented. In some illustrative examples, one or more of the components may be incorporated in or otherwise form a portion of another component. For example, the 1106, or portions thereof, may be incorporated in processor unit 1104 in some illustrative examples. The different illustrative embodiments can be implemented in a data processing system including components in addition to or in place of those illustrated for data processing system 1100. Other components shown in FIG. 11 can be varied from the illustrative examples shown. The different embodiments can be implemented using any hardware device or system capable of running program code 1118.

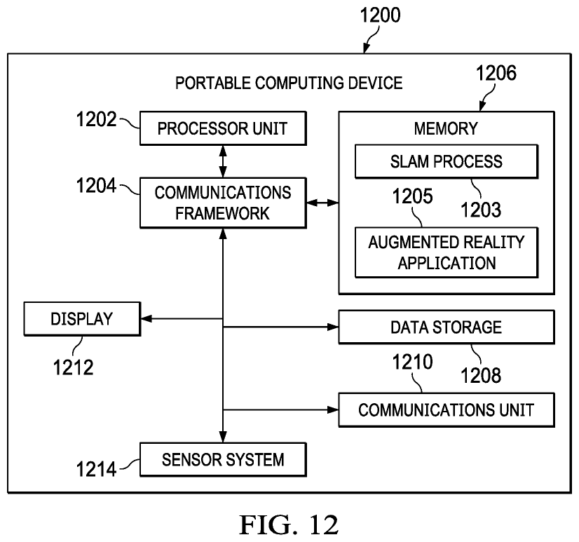

With reference to FIG. 12, an illustration of a block diagram of a portable computing device is depicted in accordance with an illustrative embodiment. Portable computing device 1200 is an example of one manner in which smart glasses 120, smart glasses 122, portable computing device 214, smart glasses 406, and smart glasses 408 can be implemented. In this illustrative example, portable computing device 1200 includes physical hardware components such as processor unit 1202, communications framework 1204, memory 1206, data storage 1208, communications unit 1210, display 1212, and sensor system 1214.

Communications framework 1204 allows different components in portable computing device 1200 to communicate with each other when connected to communications framework 1204. Communications framework 1204 is a bus system in this illustrative example.

Processor unit 1202 processes program code for software loaded into memory 1206. Processor unit 1202 include one or more processors. For example, processor unit 1202 can be selected from at least one of a multicore processor, a central processing unit (CPU), a graphics processing unit (GPU), a physics processing unit (PPU), a digital signal processor (DSP), a network processor, or some other suitable type of processor.

Memory 1206 is connected to processor unit 1202 through communications framework 1204. As depicted, memory 1206 can include at least one of a random-access memory (RAM), a read-only memory (ROM), a static random-access memory (SRAM), a dynamic random-access memory (DRAM), or other suitable types of memory devices or circuits.

As depicted, data storage 1208 is connected to communications framework 1204 and can store data, program code, or other information. Instructions in program code can be loaded from data storage 1208 into memory 1206 for processing by processor unit 1202. For example, the instructions in program code can include a simultaneous localization and mapping (SLAM) process 1203 and an augmented reality application 1205 for displaying task information on a live view of an object.

Data storage 1208 can comprise at least one of a hard disk drive, a flash drive, a solid-state disk drive, an optical drive, or some other suitable type of data storage device or system. Data storage 1208 can store scan data, a map of an object, a model of the object, or other suitable information for use in an augmented reality display of task information overlaying a live view of an object.

In this illustrative example, communications unit 1210 provides for communications with other data processing systems or devices. In these illustrative examples, communications unit 1110 includes at least one of a network interface card, a wireless communications device, a universal serial bus port, or other suitable device.

Display 1212 is connected to communications framework 1204 and provides a mechanism to display information to a user. In this example, display 1212 can be a touch screen display, which enables receiving user input through this display.

In this illustrative example, sensor system 1214 is connected to communications framework 1204. As depicted, sensor system 1214 can include hardware, software, or both. In this illustrative example, sensor system 1214 can include at least one of a laser scanner, a structured light three-dimensional scanner, a camera, or an infrared light scanner.

The illustration of portable computing device 1200 is an example of one manner in which portable computing device 1200 can be implemented. This illustration is not meant to limit the manner in which portable computing device 1200 can be embodied in other illustrative examples. For example, portable computing device 1200 can also include an audio interface in which an audio output device generates sound.

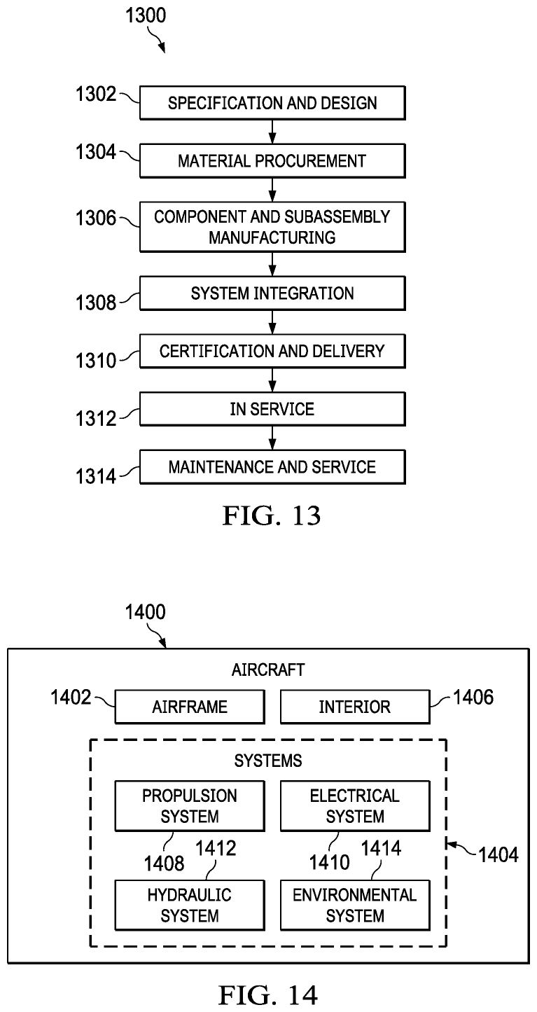

Illustrative embodiments of the disclosure may be described in the context of aircraft manufacturing and service method 1300 as shown in FIG. 13 and aircraft 1400 as shown in FIG. 14. Turning first to FIG. 13, an illustration of an aircraft manufacturing and service method is depicted in accordance with an illustrative embodiment. During pre-production, aircraft manufacturing and service method 1300 may include specification and design 1302 of aircraft 1400 in FIG. 14 and material procurement 1304.

During production, component and subassembly manufacturing 1306 and system integration 1308 of aircraft 1400 in FIG. 14 takes place. Thereafter, aircraft 1400 in FIG. 14 may go through certification and delivery 1310 in order to be placed in service 1312. While in service 1312 by a customer, aircraft 1400 in FIG. 14 is scheduled for routine maintenance and service 1314, which may include modification, reconfiguration, refurbishment, and other maintenance or service.

Each of the processes of aircraft manufacturing and service method 1300 may be performed or carried out by a system integrator, a third party, an operator, or some combination thereof. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 14, an illustration of an aircraft is depicted in which an illustrative embodiment may be implemented. In this example, aircraft 1400 is produced by aircraft manufacturing and service method 1300 in FIG. 13 and may include airframe 1402 with plurality of systems 1404 and interior 1406. Examples of systems 1404 include one or more of propulsion system 1408, electrical system 1410, hydraulic system 1412, and environmental system 1414. Any number of other systems may be included. Although an aerospace example is shown, different illustrative embodiments may be applied to other industries, such as the automotive industry.

Apparatuses and methods embodied herein may be employed during at least one of the stages of aircraft manufacturing and service method 1300 in FIG. 13.

In one illustrative example, components or subassemblies produced in component and subassembly manufacturing 1306 in FIG. 13 may be fabricated or manufactured in a manner similar to components or subassemblies produced while aircraft 1400 is in service 1312 in FIG. 13. As yet another example, one or more apparatus embodiments, method embodiments, or a combination thereof may be utilized during production stages, such as component and subassembly manufacturing 1306 and system integration 1308 in FIG. 13. One or more apparatus embodiments, method embodiments, or a combination thereof may be utilized while aircraft 1400 is in service 1312, during maintenance and service 1314 in FIG. 13, or both.

For example, augmented reality system 210 can be used to provide visualizations of task locations. These visualizations can include displaying task information to be performed at the task locations. Augmented reality system 210 can be utilized by human operators during at least one of component and subassembly manufacturing 1306, system integration 1308, certification and delivery 1310, or maintenance and service 1314.

The use of a number of the different illustrative embodiments may substantially expedite the assembly of aircraft 1400, reduce the cost of aircraft 1400, or both expedite the assembly of aircraft 1400 and reduce the cost of aircraft 1400. For example, the use of augmented reality system 210 can increase accuracy in which operations are performed by human operators during various steps such as component and subassembly manufacturing 1306, system integration 1308, or maintenance and service 1314.

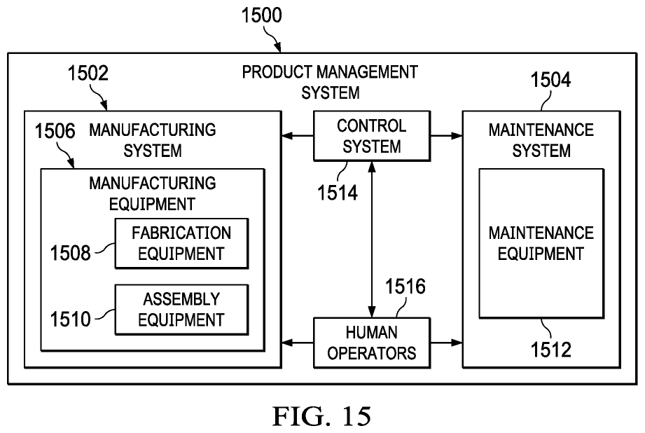

Turning now to FIG. 15, an illustration of a block diagram of a product management system is depicted in accordance with an illustrative embodiment. Product management system 1500 is a physical hardware system. In this illustrative example, product management system 1500 may include at least one of manufacturing system 1502 or maintenance system 1504.

Manufacturing system 1502 is configured to manufacture products, such as aircraft 1400 in FIG. 14. As depicted, manufacturing system 1502 includes manufacturing equipment 1506. Manufacturing equipment 1506 includes at least one of fabrication equipment 1508 or assembly equipment 1510.

Fabrication equipment 1508 is equipment that may be used to fabricate components for parts used to form aircraft 1400 in FIG. 14. For example, fabrication equipment 1508 may include machines and tools. These machines and tools may be at least one of a drill, a hydraulic press, a furnace, a mold, a composite tape laying machine, a vacuum system, a lathe, or other suitable types of equipment. Fabrication equipment 1508 may be used to fabricate at least one of metal parts, composite parts, semiconductors, circuits, fasteners, ribs, skin panels, spars, antennas, or other suitable types of parts.

Assembly equipment 1510 is equipment used to assemble parts to form aircraft 1400 in FIG. 14. In particular, assembly equipment 1510 may be used to assemble components and parts to form aircraft 1400 in FIG. 14. Assembly equipment 1510 also may include machines and tools. These machines and tools may be at least one of a robotic arm, a crawler, a faster installation system, a rail-based drilling system, or a robot. Assembly equipment 1510 may be used to assemble parts such as seats, horizontal stabilizers, wings, engines, engine housings, landing gear systems, and other parts for aircraft 1400 in FIG. 14.

In this illustrative example, maintenance system 1504 includes maintenance equipment 1512. Maintenance equipment 1512 may include any equipment needed to perform maintenance on aircraft 1400 in FIG. 14. Maintenance equipment 1512 may include tools for performing different operations on parts on aircraft 1400 in FIG. 14. These operations may include at least one of disassembling parts, refurbishing parts, inspecting parts, reworking parts, manufacturing replacement parts, or other operations for performing maintenance on aircraft 1400 in FIG. 14. These operations may be for routine maintenance, inspections, upgrades, refurbishment, or other types of maintenance operations.

In the illustrative example, maintenance equipment 1512 may include ultrasonic inspection devices, x-ray imaging systems, vision systems, drills, crawlers, and other suitable devices. In some cases, maintenance equipment 1512 may include fabrication equipment 1508, assembly equipment 1510, or both to produce and assemble parts that may be needed for maintenance.

Product management system 1500 also includes control system 1514. Control system 1514 is a hardware system and may also include software or other types of components. Control system 1514 is configured to control the operation of at least one of manufacturing system 1502 or maintenance system 1504. In particular, control system 1514 may control the operation of at least one of fabrication equipment 1508, assembly equipment 1510, or maintenance equipment 1512.

The hardware in control system 1514 may be implemented using hardware that may include computers, circuits, networks, and other types of equipment. The control may take the form of direct control of manufacturing equipment 1506. For example, robots, computer-controlled machines, and other equipment may be controlled by control system 1514. In other illustrative examples, control system 1514 may manage operations performed by human operators 1516 in manufacturing or performing maintenance on aircraft 1400. For example, control system 1514 may assign tasks, provide instructions, display models, or perform other operations to manage operations performed by human operators 1516.

In these illustrative examples, augmented reality system 210 in FIG. 2 and FIG. 3 can be implemented for use with control system 1514 to manage at least one of the manufacturing or maintenance of aircraft 1400 in FIG. 14. For example, augmented reality system 210 can operate to provide human operators 1516 instructions and guidance for performing operations on an object. These operations can include operations to manufacture or operation for maintenance of the object. For example, control system 1514 can assign tasks such as laying up composite plies on a tool to one or more of human operators 1516. Control system 1514 can send task information to augment live views to portable computing devices 214 in augmented reality system 210 worn or carried by human operators 1516.

In the different illustrative examples, human operators 1516 may operate or interact with at least one of manufacturing equipment 1506, maintenance equipment 1512, or control system 1514. This interaction may be performed to manufacture aircraft 1400 in FIG. 14.

Of course, product management system 1500 may be configured to manage other products other than aircraft 1400 in FIG. 14. Although product management system 1500 has been described with respect to manufacturing in the aerospace industry, product management system 1500 may be configured to manage products for other industries. For example, product management system 1500 can be configured to manufacture products for the automotive industry as well as any other suitable industries.

Thus, the illustrative embodiments provide a method, apparatus, and system for visualizing task locations. The visualization of task locations includes displaying information used to perform operations at the task locations in addition to identifying the task locations. In one illustrative example, one or more technical solutions are present that overcome a technical problem with a technical problem with providing a guide for placing a ply on a tool. In the illustrative examples, one or more technical solutions provide visualizations of task locations using portable computing devices in place of an overhead laser tracker.

In the illustrative examples, one or more technical solutions use scans of the tool from multiple portable computing devices at different viewpoints to increase the accuracy of the visualizations of task locations. Thus, one or more technical solutions in the illustrative examples involves combining scan data received from the portable computing devices to form a combined map of the object, such as a tool, such that scan data from one portable computing device that is missing scan data for a portion of the tool can be supplemented with scan data including the portion of the tool from another portable computing device.

As a result, one or more technical solutions may provide a technical effect providing visualization of task locations on objects with increased accuracy by using scan data from multiple portable computing devices as compared to currently used techniques.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method for visualizing task information for a layup location on a tool, the method comprising:
scanning a tool using portable computing devices on human operators at different viewpoints to the tool to generate scan data;
creating, by a computer system, point clouds from the scan data generated by the portable computing devices;
creating, by the computer system, a combined map of the tool using the point clouds;
localizing a portable computing device in the portable computing devices to the tool using the combined map of the tool; and
displaying, by the portable computing device, the task information for the layup location on the tool on a live view seen through a display device in the portable computing device that has been localized using the combined map of the tool and a ply model of composite plies, wherein displayed task information augments the live view of the tool.

2. The method of claim 1 further comprising:
placing a composite ply using a guide in the task information displayed on the live view of the layup location on the tool, wherein the guide aids in placement of a number of the composite plies on the tool.

3. The method of claim 1, wherein displaying the task information for the layup location on the tool comprises:
identifying the layup location in the ply model of the composite plies;
determining a layup location on the live view for a number of guides for a number of the composite plies using the ply model and the combined map; and
displaying, by the portable computing device, the number of guides for the number of the composite plies at the layup location on the live view of the tool seen through the display device in in the portable computing device that has been localized, wherein the number of guides aids in placement of the number of the composite plies on the tool.

4. The method of claim 3 further comprising:
displaying, by the portable computing device, a number of additional guides for the number of the composite plies at the layup location on the live view of the tool seen through the display device in the portable computing device that has been localized, wherein the number of additional guides illustrates a number of prior placements for the number of the composite plies on the tool.

5. The method of claim 3, wherein displaying task information for the layup location on the tool further comprises:
displaying at least one of a ply number, an instruction, an image, or video for placing the number of the composite plies.

6. The method of claim 1, wherein creating the combined map of the tool from the point clouds comprises:
creating a map from each point cloud in the point clouds to form a plurality of maps; and
combining the plurality of maps to form the combined map of the tool.

7. The method of claim 6, wherein combining the plurality of maps to form the combined map comprises:
identifying common reference points in the plurality of maps; and
combining the plurality of maps using the common reference points, wherein the combined map has increased accuracy from the plurality of maps created from scan data generated from the different viewpoints.

8. The method of claim 1, wherein localizing a portable computing device in the portable computing devices to the tool using the model comprises:
localizing the portable computing device in the portable computing devices to the tool using the combined map and a simultaneous localization and mapping process.

9. The method of claim 1, wherein the task information for the layup location is a guide to layup a composite ply for at least one of fabricating a composite part or reworking the composite part.

10. The method of claim 1, wherein the tool is selected from a group comprising a mandrel, a mold, a composite tool.

11. The method of claim 1, wherein the portable computing devices are selected from at least one of smart glasses, a mobile phone, a tablet computer, or a head mounted display.

12. The method of claim 1, wherein the portable computing devices scan the tool using at least one of a laser scanner, a structured light three-dimensional scanner, or an infrared light scanner.

13. A method for augmenting a live view of a task location, the method comprising:
localizing a portable computing device to an object; and
displaying a visualization of a task location on the live view of the object for performing a task using a model of the object and a combined map of the object, wherein the combined map is generated from scans of the object by portable computing devices at different viewpoints to the object.

14. The method of claim 13 further comprising:
receiving scan data from the portable computing devices including the portable computing device, wherein the scan data is generated from scanning the object with the portable computing devices on human operators at different viewpoints to the object.

15. The method of claim 14, wherein the scan data is received in real-time.

16. The method of claim 14 further comprising:
creating, by a computer system, point clouds from the scan data generated by the portable computing devices; and
creating, by the computer system, the combined map of the object using the point clouds.

17. The method of claim 16, wherein creating, by the computer system, the combined map of the object using the point clouds comprises:
creating a map from each point cloud in the point clouds to form a plurality of maps; and
combining the plurality of maps to form the combined map.

18. The method of claim 13, wherein the task location is for at least one of a composite ply, a part in an assembly in which the object is the assembly, a plaque, or an applique.

19. The method of claim 13, wherein the task is selected from at least one of placing a composite ply, applying a plague, applying an applique, performing an inspection of the task location, drilling a hole, installing a fastener, connecting a part to an assembly, or removing a part.

20. The method of claim 13, wherein the object is selected from a group comprising a tool, a wall, a workpiece, a wing, a fuselage section, an engine, a building, an aircraft, and a vehicle.

21. An augmented reality system for visualizing a layup location on a tool, the augmented reality system comprising:
a computer system operates to
receive scan data from using portable computing devices on human operators at different viewpoints to the tool to generate scan data;
create a plurality of maps of the tool using the scan data generated by the portable computing devices;
combine the plurality of maps to form a combined map of the tool;
identify task information for the layup location in a ply model; and
send the task information of the layup location on the tool to a portable computing device in the portable computing devices, wherein the portable computing device displays the task information for the layup location on the tool on a live view seen through a display device in the portable computing device that has been localized using the combined map of the tool and a ply model of composite plies.

22. The augmented reality system of claim 21, wherein the augmented reality system further comprises the portable computing device and wherein the portable computing device identifies the layup location in the ply model of the composite plies; determines a location on the live view for a number of guides for a number of the composite plies using the ply model and the combined map; and displays the number of guides for the number of the composite plies at the location on the live view of the tool seen through the display device in the portable computing device that has been localized, wherein the number of guides is a guide for placement of the number of the composite plies on the tool.

23. The augmented reality system of claim 22, wherein portable computing device displays at least one of a ply number, an instruction, an image, or video for placing the number of the composite plies.

24. The augmented reality system of claim 21, wherein the scan data comprises point clouds and wherein in creating the combined map, the computer system operates to:
create a map from each point cloud in the point clouds to form a plurality of maps; and
combine the plurality of maps to form the combined map.

25. The augmented reality system of claim 21, wherein in combining the plurality of maps to form the combined map, the computer system operates to
identify common reference points in the plurality of maps;
combine the plurality of maps using the common reference points, wherein the combined map has increased accuracy from the plurality of maps created from scan data generated the different viewpoints.

26. The augmented reality system of claim 21, wherein the portable computing device in the portable computing devices is localized to the tool using the combined map and a simultaneous localization and mapping process.

27. The augmented reality system of claim 21, wherein the task information for the layup location is a guide to layup a composite ply for at least one of fabricating a composite part or reworking the composite part on the tool.

28. The augmented reality system of claim 21, wherein the tool is selected from a group comprising a mandrel, a mold, a composite tool.

29. An augmented reality system for augmenting a live view of a task location, the augmented reality system comprising:
a portable computing device, wherein the portable computing device is localized to an object and displays a visualization of a task location on the live view of the object for performing a task using a model of the object and a combined map of the object, wherein the combined map is generated from scans of the object by portable computing devices at different viewpoints to the object.

30. The augmented reality system of claim 29 further comprising:
a computer system in communication with the portable computing device, wherein the computer system operates to receive scan data from portable computing devices including the portable computing device, wherein the scan data is generated from scanning the object with the portable computing devices on human operators at different viewpoints to the object. create point clouds from the scan data generated by the portable computing devices; and
create a combined map of the object using the point clouds.

31. The augmented reality system of claim 30, wherein the scan data is received in real-time.

32. The augmented reality system of claim 30, wherein in creating the combined map of the object using the point clouds, the computer system creates a map from each point cloud in the point clouds to form a plurality of maps and combines the plurality of maps to form the combined map.

33. The augmented reality system of claim 29, wherein the task location is for at least one of a composite ply, a part in an assembly in which the object is the assembly, a plaque, or an applique.

34. The augmented reality system of claim 29, wherein the task is selected from at least one of placing a composite ply, applying a plague, applying an applique, performing an inspection of the task location, drilling a hole, installing a fastener, connecting a part to an assembly, or removing a part.

35. The augmented reality system of claim 29, wherein the object is selected from a group comprising a tool, a wall, a workpiece, a wing, a fuselage section, an engine, a building, an aircraft, and a vehicle.
